(19) United States
(12) Patent Application Publication
(10) Pub. No.: US 2026/0298809 A1
(43) Pub. Date: Oct. 1, 2026

(54) SINGLE POINT ANALYZER

(71) Applicant: TOMRA SORTING GMBH, Mülheim-Kärlich (DE)

(72) Inventor: Dirk BALTHASAR, Boppard (DE)

(73) Assignee: TOMRA SORTING GMBH, Mülheim-Kärlich (DE)

(21) Appl. No.: 19/479,785

(22) PCT Filed: May 6, 2024
(86) PCT No.: PCT/EP2024/062471

§ 371 Date: Oct. 29, 2025

(30) Foreign Application Priority Data
May 5, 2023 (EP) 23171890.9

(51) Int. Cl. G01N 21/27; G01N 21/31; G01N 21/85

(52) U.S. Cl. CPC G01N 21/276; G01N 21/31; G01N 21/85; G01N 2021/3155; G01N 2021/8592

(57) ABSTRACT

An inspection system configured to detect and analyse matter, which includes an irradiation arrangement for emitting optical radiation for irradiating said matter, a detector system with at least one detector adapted to receive and detect optical radiation, a white reference target element, and a switching element comprising at least one inspection zone, at least one dark reference zone and at least one white reference zone. The switching element is rotatable between at least one inspection position, in which said inspection zone transmits optical radiation originating from said matter towards said detector system, at least one dark reference position, in which said switching element blocks at least most of the optical radiation originating from said matter from reaching said detector system, and at least one white reference position, in which said switching element blocks at least most of the optical radiation originating from said matter from reaching said detector system.

### TECHNICAL FIELD

The inventive concept described herein generally relates to inspection systems for detecting and analyzing matter and to a method for calibrating such an inspection system.

### BACKGROUND

There is constant development in the field of automated detection and analysis of objects, with applications in a wide range of industries. Sensor-based sorting systems are for example used in the recycling and waste management industry. Classification and sorting of objects is based on properties of the objects, which are analysed by a detector system comprising for example a spectroscopy system, a laser triangulation system, and/or a camera-based system. To ensure good quality of the data obtained by such a detector system, calibration of the detector must be regularly calibrated.

Commonly, to perform a calibration the measuring of the objects is discontinued, and reference elements are placed in the inspection area so that these are measured by the detector instead of the objects at regular time intervals, e.g. every five minutes. A drawback of such a procedure is that measurement operation of the system is interrupted during the calibration process, and no measurement in the inspection area is possible during this time.

Furthermore, sensor-based sorting systems are commonly used in parallel and/or series configuration in material recycling plants. Optimised material analysis in a recycling process flow and in particular in such a material recycling plant supervision are constantly needed. A drawback of existing material analysis in such material recycling plants to enable monitoring of the recycling process flow, sorting quality controls and/or maintenance or performance controls, etc., is to find cost-effective solutions without causing severe process flow disruptions.

U.S. Pat. No. 5,991,046 discloses a method and apparatus for measuring and controlling optical properties of a moving web. The apparatus comprises a calibration unit comprising an operating element being a hole in the calibration unit, a non-glossy non-fluorescent reference of known high diffuse reflectivity for white level calibration, and a black reference such as a cavity or other light trap, or a non-glossy non-fluorescent black tile or known low diffuse reflectivity for black level calibration.

DE10318892A1 discloses a system for continuous online reference calibration of a spectrographic near infrared (NIR) measurement system, wherein a movable reference disk is placed between a measurement head and the plane in which passing product is inspected. The disk is rotated or displaced to permit positioning of calibration or reference standards temporarily in front of the measurement head.

### SUMMARY

In light of the above, it is an object of the present inventive concept to provide an apparatus for an inspection system and a method for calibrating as well as a cost-effective means for recycling plant supervision and monitoring, where such an inspection system present advantages in terms of providing a reliable calibration and/or plant supervision and monitoring at regular intervals without interrupting the measurement operation.

According to a first aspect of the present inventive concept, there is provided an inspection system configured to detect and analyse matter arranged in an inspection area, which inspection system comprises:
an irradiation arrangement for emitting optical radiation within a first predetermined wavelength range such as UV, VIS, MIR and/or NIR for irradiating said matter,
a detector system with at least one detector adapted to receive and detect signature radiation within a second predetermined wavelength range such as UV, VIS, MIR and/or NIR, which signature radiation is optical radiation reflected, scattered and/or emitted by said matter,
a switching element arranged to be rotatable around a rotation axis between at least one inspection position, at least one dark reference position and at least one white reference position,
a white reference target element configured to be irradiated by reference radiation and configured to redirect or reflect said reference radiation towards said switching element, which reference radiation is optical radiation emitted by said irradiation arrangement, and
an optical arrangement for redirecting said signature radiation towards said switching element,
wherein said switching element comprises a plate, which plate comprises:
   at least one inspection zone, each said inspection zone being an opening or window in said plate,
   at least one dark reference zone, each said dark reference zone being an opaque portion of said plate, and
   at least one white reference zone, each said white reference zone comprises an opening or an optical window in said plate, and an associated reflective element, which associated reflective element comprises a reflective surface, which reflective element is arranged such that, in said at least one white reference position of the switching element, said reflective surface of the reflective element is irradiated by said reference radiation and redirects said reference radiation towards said detector system and said reflective element blocks said signature radiation from reaching said detector system, and
wherein said switching element is arranged to be rotatable around said rotation axis such that:
in each of said at least one inspection position of the switching element, a respective one of said at least one inspection zone transmits said signature radiation after it has been redirected by said optical arrangement, and transmits said signature radiation towards said detector system,
in each of said at least one dark reference position of the switching element, a respective one of said at least one dark reference zone blocks all or at least most of the signature radiation from reaching said detector system,
in each of said at least one white reference position of the switching element a respective associated reflective element being associated with a respective white reference zone is configured to be irradiated by said signature irradiation, and said associated reflective element is configured to block said signature radiation from reaching said detector system, and
   said reflective surface of said respective associated reflective element is configured to be irradiated by said reference irradiation and to reflect or redirect said reference irradiation towards said respective white reference zone, and said opening or optical window of said respective white reference zone is configured to transmit said reference radiation towards said detector system.

In the expression “a respective associated reflective element being associated with a respective white reference zone is configured to be irradiated by said signature radiation”, the “respective white reference zone” should be understood as a respective one of said at least one white reference zone. Further, it should be understood that the associated reflective element is configured to be irradiated by said signature radiation.

In the context of this disclosure, the expression “optical radiation originating from said matter” should be construed as optical radiation reflected, scattered and/or emitted by the matter. This may be referred to as “signature radiation”. The expression “optical radiation originating from said white reference target element” should be construed as optical radiation redirected by said white reference target element.

Alternatively, there is provided an inspection system configured to detect and analyse matter arranged in an inspection area, which inspection system comprises:
an irradiation arrangement for emitting optical radiation within a first predetermined wavelength range such as UV, VIS, MIR and/or NIR for irradiating said matter,
a detector system with at least one detector adapted to receive and detect optical radiation within a second predetermined wavelength range such as UV, VIS, MIR and/or NIR, which optical radiation is reflected, scattered and/or emitted by said matter,
an optical arrangement for redirecting said optical radiation reflected, scattered and/or emitted by said matter towards said at least one detector,
a white reference target element, and
a switching element comprising at least one inspection zone, at least one dark reference zone and at least one white reference zone.

The switching element may be arranged to be rotatable around a rotation axis between at least one inspection position, at least one dark reference position and at least one white reference position, such that:
in each of said at least one inspection position of the switching element, a respective one of said at least one inspection zone transmits optical radiation originating from said matter and redirected by said optical arrangement towards said detector system,
in each of said at least one dark reference position of the switching element, said switching element blocks at least most of the optical radiation originating from said matter from reaching said detector system and a respective one of said at least one dark reference zone faces said at least one detector,
in each of said at least one white reference position of the switching element, said switching element blocks at least most of the optical radiation originating from said matter from reaching said detector system and a respective one of said at least one white reference zone redirects and transmits optical radiation originating from said white reference target element towards said detector system.

According to a second aspect of the present inventive concept, there is provided a method for calibrating an inspection system configured to detect and analyse matter arranged in an inspection area, which inspection system comprises:
an irradiation arrangement for emitting optical radiation within a first predetermined wavelength range such as UV, VIS, MIR and/or NIR,
a detector system with at least one detector adapted to receive and detect signature radiation, which signature radiation is optical radiation reflected, scattered and/or emitted by said matter, and
a switching element arranged to be rotatable around a rotation axis between at least one inspection position, at least one dark reference position and at least one white reference position, wherein said switching element comprises a plate, which plate comprises: at least one inspection zone, each said inspection zone being an opening or window in said plate, at least one dark reference zone, each said dark reference zone being an opaque portion of said plate, and at least one white reference zone, each said white reference zone comprising an opening or optical window in said plate and an associated reflective element, which associated reflective element comprises a reflective surface,
a white reference target element, and
an optical arrangement for redirecting said signature radiation towards said switching element,
the method comprising:
emitting, by said irradiation arrangement, optical radiation within a first predetermined wavelength range such as UV, VIS, MIR and/or NIR, for irradiating said matter,
redirecting, by said optical arrangement, said signature radiation towards said switching element,
a step of rotating said switching element into an inspection position of said switching element, wherein said signature radiation is received from said optical arrangement and transmitted by a respective one of said at least one inspection zone of said switching element and thereafter received by the at least one detector,
a step of rotating said switching element into a dark reference position of said switching element, wherein a respective one of said at least one dark reference zone blocks all or at least most signature radiation from reaching said detector system, and a dark reference level is measured on said respective one of said at least one dark reference zone of the switching element by said at least one detector,
a step of rotating said switching element into a white reference position of said switching element and irradiating said white reference target element with reference radiation, which reference radiation is optical radiation emitted by said irradiation arrangement, wherein said reflective element of a respective one of said at least one white reference zone blocks at least most signature radiation from reaching said detector system, while said reference radiation is:
redirected or reflected, by said white reference target element, towards said switching element,
thereafter redirected or reflected, by said reflective surface of said reflective element, towards said detector system, and thereafter transmitted, by said opening or optical window of said respective one of said at least one white reference zone, towards said detector system, and
a white reference level is measured on said white reference target element by said at least one detector.

Alternatively, there is provided a method for calibrating an inspection system configured to detect and analyse matter arranged in an inspection area, which inspection system comprises:
a detector system with at least one detector adapted to receive and detect optical radiation originating from said matter, and
a switching element comprising at least one inspection zone, at least one dark reference zone and at least one white reference zone.

The method may comprise:
a step of rotating said switching element into an inspection position of said calibration element and receiving, by the at least one detector, optical radiation originating from said matter and transmitted by said at least one inspection zone of said switching element,
a step of rotating said switching element into a dark reference position of said switching element, such that said switching element blocks at least most optical radiation originating from said matter from reaching said detector system, and measuring a dark reference level on said at least one dark reference zone of the switching element, and
a step of rotating said switching element into a white reference position of said switching element, such that said switching element blocks at least most optical radiation originating from said matter from reaching said detector system, and measuring a white reference level on a white reference target element, wherein optical radiation originating from said white reference target element is redirected and transmitted towards said detector system by said at least one white reference zone of said switching element.

According to a third aspect of the present inventive concept, there is provided a sorting system for sorting objects, comprising:
upstream conveying means and at least a first and second downstream conveying means, each of said upstream conveying means and said at least a first and second downstream conveying means comprising at least one of a conveying belt, a chute or a freefall path,
analysing means configured to analyse and determine at least one property of said objects being transported on said upstream conveying means,
sorting means configured to:
   sort said objects into one of at least a first and a second category according to a first and a second criteria based on said at least one property, and
   provide said objects sorted into said first category to said first downstream conveying means and said objects sorted into said second category to said second downstream conveying means,

The sorting system may further comprise an inspection system according to the first aspect, arranged such that said inspection area coincides with at least a part of said first downstream conveying means. The inspection system may be configured to:
determine said at least one property of said objects passing through said inspection area,
determine if said at least one property of said objects passing through said inspection area satisfies said first criteria, and
establish a quality score based on the ratio of the number of times said at least one property of an object passing through said inspection area satisfies said first criteria and the number of determinations of said at least one property of an object passing through said inspection area.

Preferred embodiments of the inventive concept are set out in the dependent claims.

The inventive concept presents at least the following advantages:
Continuous white calibration and dark calibration of the inspection system is provided,
Only one moving element is needed to provide white calibration and dark calibration,
The system is thereby very reliable, and
The present inventive concept allows for a compact design of the inspection system.

In the context of this disclosure, continuous calibration means that during operation of an inspection system according to the first aspect, the calibration process is performed concurrently with the measurement process. In more detail, the detector of the detector system may operate at a given sample rate, for example 40 kHz. When the switching element is in its inspection position, the detector receives and detects signature radiation from the matter in the inspection area and the detected optical radiation is integrated over the time during which the switching element is in its inspection position. This may be referred to as a measurement. A dark calibration of the detector is performed when the switching element is in its dark reference position. A white calibration is performed when the switching element is in its white reference position. Thereby each measurement may be calibrated using a dark calibration and/or a white calibration performed within one revolution of the switching element.

Thus, from the point of view of an operator of the inspection system, the calibration process is not separate from the measurement process. This increases the available time for measurement, as the measurement process does not have to be interrupted to perform a dark and/or white calibration.

The switching element may comprise two or more inspection zones, two or more dark reference zones and two or more white reference zones. For example, the switching element may comprise 2-8 inspection zones, 2-8 dark reference zones and 2-8 white reference zones. The switching element may have an even number of inspection zones, dark reference zones, and/or white reference zones. The switching element may have an uneven number of inspection zones, dark reference zones and/or white reference zones.

In embodiment where the switching element has two or more inspection zones, two or more dark reference zones and two or more white reference zones, each inspection position of the switching element is associated with a respective one of the inspection zones, each dark reference position of the switching element is associated with a respective one of the dark reference zones and each white reference position of the switching element is associated with a respective one of the white reference zones.

In some example embodiments, the switching element may be arranged to rotate at 1400 rpm, 2000 rpm, 2500 rpm, or 3000 rpm, or any rotation speed in the range 1 rpm-10000 rpm. When the inspection system is used for inspecting a stream of samples conveyed by conveying means in a sorting plant a rotation speed of within an interval of 100 to 10000 rpm may be suitable. When the inspection system is used for inspecting a few samples conveyed by conveying means in a sorting table a rotation speed of within an interval of 10 to 5000 rpm may be suitable. When the inspection system is part of a handheld unit a rotation speed of within an interval of 1 to 1000 rpm may be suitable.

The rotation speed of the switching element is preferably adapted to the number of inspection zones comprised in the switching element to obtain a suitable number of measurements per minute, dependent on the application at hand.

The inspection system may be adapted to perform single point analysis. The inspection system may thus be arranged such that optical radiation emitted by the irradiation arrangement is directed to the matter in the inspection zone following a fixed optical path. In other words, the optical path of the optical radiation emitted by the irradiation arrangement does not change during operation of the inspection system and the optical radiation emitted by the irradiation arrangement is not scanned over the inspection area.

The matter may be transported through the inspection area, for example on a conveyor belt. Additionally or alternatively, the matter may be transported through the inspection area on a chute or slide, or in a free fall. Additionally or alternatively, the matter may be static in the inspection area, at least during a measurement.

The inspection area may be defined as a 2D area. For instance, the inspection area may be a portion of the conveyor belt or of the chute or slide on which the matter is transported through the inspection area. The inspection area may be a stage of the inspection system. The stage may be movable to transport the matter into an appropriate measurement position. The stage may be static during measurement.

In embodiments where the inspection area is a portion of a conveyor belt on which the matter is transported through the inspection area, the inspection system may be configured to switch off the irradiation arrangement when the conveyor belt is stopped. This may avoid build-up of heat on the surface of the conveyor belt in the inspection area.

In embodiments where the stage of the inspection system is static, the inspection area may be provided by means that prevent heat for example with a honeycomb structure, on which the matter to be inspected is arranged. The honeycomb structure may be arranged above a void or a box filled with air. Irradiation from the irradiation arrangement may thus at least partly go through the honeycomb structure and heat build-up may be avoided. This may allow the surface temperature at the inspection area to remain within acceptable temperatures for finger contact, thus improving safety for the operator.

In embodiments where the stage of the inspection system is static, the inspection area may be provided with means that remove heat from the inspection area like cooling systems using for example convection, air flow or water to allow a safe operation for the operator.

The inspection system may be a handheld measuring device for portable use. In such a configuration, the inspection area may change depending on the orientation of the handheld measuring device, i.e. where it is pointed.

For example, the inspection system may be arranged to analyse matter transported on a conveyor belt in a sorting plant. The inspection system being a single point analyser, all material being transported on the conveyor may not be analysed, i.e. the field of view of the inspection system does not cover the full width of the conveyor belt. However, valuable statistical data may be provided. For instance, if matter transported on the conveyor is randomly distributed over the width of the conveyor, a sufficiently large sample (i.e. sufficient number of measurements over a sufficient time frame) collected by the single point analyser may be representative of the matter being transported in the conveyor.

According to one example, such a system may be used downstream of a sorting arrangement in a sorting plant, to e.g. control the quality of the sorting process. A sorting process may separate one material stream into two separate streams of materials with different properties. For example, a stream of PET bottles may be sorted into a first stream of clear PET bottles, and a second stream of coloured PET bottles; a plurality streams may also be provided selected from a group comprising for example one stream with clear plastic, one with white plastic, one with red plastic, one with blue plastic, one with foreign material and a combination thereof.

An inspection system according to the present inventive concept may be arranged to inspect part of the first stream and assess the quality of the sorting: any coloured PET bottles or other residues are detected by the system means that an error in the sorting process has occurred.

The inspection system may also be an offline inspection system, i.e. operating outside of the flow of matter in a sorting plant. For example, in the sorting plant, there may be materials that are not correctly detected by the systems in place. A sample of this material can be analysed offline to obtain training data for the sorting system. The result is fed into a learning algorithm to build classifiers and configure the sorting system.

The irradiation arrangement preferably comprises at least one irradiation/illumination source selected from the group comprising LEDs, halogen lamps, and/or lasers. For example, the irradiation source may be a broadband spectral source, such as a halogen light source. A suitable halogen light source may have a spectral distribution starting at about 400 nm and significantly decaying at about 2.5 μm. A maximum emission power may occur at about 1.3 μm. As an alternative, Xenon arc light sources may be used for an irradiation source. A shorter wavelength such as from 200 nm and above may be achieved by using a Xenon arc light source. As a further alternative, an LED light source may be used for an irradiation source.

Additionally, or alternatively, irradiation sources that are also suitable for spectroscopy may be used as an irradiation source. For example, for UV-Fluorescence spectroscopy LED light sources may be used to advantage. For mid infrared spectroscopy heating elements may be used to advantage. For high spatial and spectral resolution spectroscopy systems, Supercontinuum lasers may be used for an irradiation source. For high spatial and spectral resolution multispectral systems, lasers at multiple wavelengths may be used in combination. For highly spatial resolution optimized multispectral systems, LEDs and Pulsed LEDs may be used for an irradiation source. Different types of irradiation sources may be combined as well.

According to at least an example embodiment, said switching element comprises a plate. Each said inspection zone may be an opening or window in said plate, each said dark reference zone may be an opaque portion of said plate, and each said white reference zone may comprise an opening or optical window in said plate and an associated reflective element comprising a reflective surface. The reflective element may be arranged such that, in said at least one white reference position of the switching element, said reflective element blocks optical radiation from said matter from reaching said detector system and said reflective surface of the reflective element redirects optical radiation originating from, or redirected by, said white reference target element towards said opening or window of said white reference zone to be transmitted towards said detector system.

In such an embodiment, the plate of the switching element may be arranged close to the detector system. This may provide a compact solution. Further, this may increase the amount of signature radiation that the switching element blocks from reaching the detector system, when in the dark reference position.

The switching element may have a generally circular shape. The plate of the switching element may thus comprise a main plate or disk comprising openings or windows for the inspection zone and white reference zones respectively. The switching element may further comprises, for each white reference zone, a protrusion comprising the reflective element.

The plate may have a diameter of 100 mm to 300 mm, or 150 mm to 250 mm, or 175 mm to 225 mm, or 5 to 100 mm, the latter size is e.g. suitable for a hand held scanner. For example, the plate may have a diameter of 200 mm to 210 mm. The plate may have a material thickness of 1 mm to 10 mm, or 0.1 to 1 mm. For example, the plate may have a material thickness of 3 mm.

According to at least one example embodiment, the switching element comprises at least two white reference zones each comprising an optical window, which optical window comprises an optical filter. Said at least two white reference zones are preferably pairwise arranged diametrically opposite each other relative said rotation axis.

This may allow for validating, monitoring or control of the spectral alignment of said detector system.

According to at least one example embodiment, said at least one white reference position comprises at least a first white reference position and a second white reference position, said white reference target element comprises a first and a second portion, and said at least one white reference zone comprises a first white reference zone and a second white reference zone. The switching element is further arranged such that when arranged in said first white reference position of the switching element, said first white reference zone redirects and transmits optical radiation originating from, or reflected or redirected by, said first portion of said white reference target element towards said detector system. The switching element is further arranged such that when arranged in said second white reference position of the switching element, said second reference zone redirects and transmits optical radiation originating from, or reflected or redirected by, said second portion of said white reference target element towards said detector system.

According to at least one example embodiment, said at least one white reference position comprises at least a first white reference position and a second white reference position, said white reference target element comprises a first and a second portion, and said at least one white reference zone comprises a first white reference zone and a second white reference zone. The switching element is further arranged such that when arranged in said first white reference position of the switching element, said first white reference zone reflects or redirects and transmits reference radiation reflected or redirected by said first portion of said white reference target element towards said detector system. The switching element is further arranged such that when arranged in said second white reference position of the switching element, said second reference zone reflects or redirects and transmits reference radiation reflected or redirected by said second portion of said white reference target element towards said detector system. Thus, in each one of said first and second white reference zone, only a respective one of the first and second portion of said white reference target element redirects radiation towards said detector.

The reference target element may thus comprise at least two portions having different properties. Reflective elements of different white reference zones may be arranged to reflect or redirect optical radiation originating from, or reflected or redirected by, different portions of said reference target element.

For example, the respective reflective elements of a first subset of white reference zones may extend out of a main plane of said plate at a first angle with respect to said main plane, and the respective reflective elements of a second subset of white reference zones may extend out of said main plane of said plate at a second angle with respect to said main plane.

Such an arrangement may allow for monitoring or control of the spectral alignment of said detector system.

According to at least one example embodiment, said switching element comprises at least two inspection zones, at least two dark reference zones, and at least two white reference zones, and each inspection zone, dark reference zone and white reference zone is arranged diametrically opposite another inspection zone, dark reference zone and white reference zone, respectively, relative said rotation axis.

In other words, the inspection zones, dark reference zones and white reference zones may be arranged symmetrically about the rotation axis of the switching element.

In such a configuration, the switching element may further be arranged such that all planes containing said rotation axis divide said switching element into two parts of substantially equal mass.

This may reduce wobble and/or vibrations of the switching element during operation of the inspection system. This is advantageous for the accuracy of the inspection system.

According to at least an example embodiment, said reflective element of each white reference zone extends out of a main plane of said plate such that a normal of said reflective surface forms an angle of 10° to 85°, or 20° to 75°, or 30° to 65°, or 40° to 50° with respect to said main plane.

This may provide for ease of placement of the white reference target. In particular, this may provide a good balance between the ability of the reflective element to block signature radiation from the matter from reaching said detector system and the ability of said reflective surface of the reflective element to reflect or redirect optical radiation originating from or reflected or redirected by said white reference target element towards said opening or window of said white reference zone to be transmitted towards said detector system.

According to at least one example embodiment the switching element further comprises at least one encoder element, or multiple encoder elements associated with zones, said encoder elements are used in operation to identify the said inspection zone, said dark reference zone or said white reference zone.

This may improve the reliability of the system and ensure that the detector system and switching element are properly synchronized.

According to at least one example embodiment the white reference target element is arranged to be irradiated by said irradiation arrangement of said inspection system.

This allows the system to operate using only one irradiation source. In turn, this may provide for lower energy consumption.

According to at least an example embodiment said detector system is a spectroscopy system.

In the context of this application a spectroscopy system is a system comprising a prism or diffraction grating for separating optical radiation into different wavelength ranges, measuring wavelengths and intensities for analysing and identifying materials.

According to one embodiment, the spectroscopy system comprises detectors sensitive at different spectral bands due to e.g. the properties of the detector material and/or optical filters provided in front of or directly in front of the detector material.

The method according to the second aspect may suitably be carried with an inspection system as described in connection with the first aspect. It should be understood that any features and embodiments of the first aspect may, as far as it is compatible with the method, be implemented in the method according to the second aspect.

### BRIEF DESCRIPTION OF THE DRAWINGS

Aspects of the present inventive concept and some non-limiting embodiments, including particular features and advantages, will now be further described with reference to the drawings, in which:

FIG. 1 is a perspective illustration of an inspection system comprising an apparatus according to the present inventive concept,

FIGS. 2a-b are illustrations of two different embodiments of the switching element,

FIGS. 3a-c are schematic illustrations of a cross-section of the inspection system with the switching element in its inspection position, dark reference position and white reference position, respectively,

FIGS. 4a-d are different views of an example arrangement of an inspection system according to the present inventive concept as a stand-alone, offline system,

FIG. 5 shows a switching element in having four white reference zones, two of which white reference zones comprising an optical window comprising an optical filter,

FIG. 6 shows a schematic view of a sorting system provided with an inspection system according to the present inventive concept.

### DETAILED DESCRIPTION

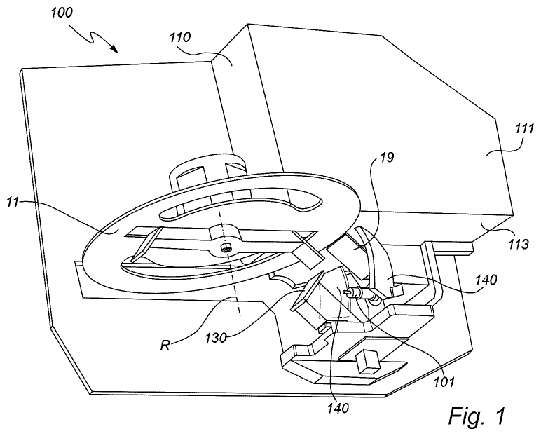

FIG. 1 illustrates an inspection system 100 according to the present inventive concept.

In general, the inspection system 100 comprises an irradiation arrangement 101, 140 for emitting optical radiation within a first predetermined wavelength range such as UV, VIS, MIR and/or NIR for irradiating said matter,
a detector system 110 with at least one detector adapted to receive and detect signature radiation within a second predetermined wavelength range such as UV, VIS, MIR and/or NIR, which signature radiation is optical radiation reflected, scattered and/or emitted by said matter,
a switching element 11 arranged to be rotatable around a rotation axis R between at least one inspection position, at least one dark reference position and at least one white reference position,
a white reference target element 19 configured to be irradiated by reference radiation and configured to redirect or reflect said reference radiation towards said switching element 11, which reference radiation is optical radiation emitted by said irradiation arrangement 101, and
an optical arrangement 130 for redirecting said signature radiation towards said switching element 11,
wherein said switching element 11 comprises a plate, which plate comprises:
at least one inspection zone, each said inspection zone being an opening or window in said plate,
at least one dark reference zone, each said dark reference zone being an opaque portion of said plate, and
at least one white reference zone, each said white reference zone comprises an opening or an optical window in said plate, and an associated reflective element, which associated reflective element comprises a reflective surface, which reflective element is arranged such that, in said at least one white reference position of the switching element, said reflective surface of the reflective element is irradiated by said reference radiation and redirects said reference radiation towards said detector system 110 and said reflective element blocks said signature radiation from reaching said detector system 110, and
wherein said switching element 11 is arranged to be rotatable around said rotation axis R such that:
in each of said at least one inspection position of the switching element 11, a respective one of said at least one inspection zone transmits said signature radiation after it has been redirected by said optical arrangement 130, and transmits said signature radiation towards said detector system,
in each of said at least one dark reference position of the switching element, a respective one of said at least one dark reference zone blocks all or at least most of the signature radiation from reaching said detector system 110,
in each of said at least one white reference position of the switching element 11 a respective associated reflective element being associated with a respective white reference zone is configured to be irradiated by said signature irradiation, and said associated reflective element is configured to block said signature radiation from reaching said detector system 110, and
said reflective surface of said respective associated reflective element is configured to be irradiated by said reference irradiation and to redirect or reflect said reference irradiation towards said respective white reference zone, and said opening or optical window of said respective white reference zone is configured to transmit said reference radiation towards said detector system 110.

The inspection system may comprise an irradiation source 101 and associated parabolic mirrors 140 for directing optical radiation from the irradiation source 101 towards matter 2 arranged in an inspection area. Optionally, the parabolic mirrors may be exchanged for another type of focusing mirrors. In other words, in the example of FIG. 1, the inspection system 100 comprises an irradiation arrangement comprising said irradiation source 101 and said parabolic mirrors 140.

An optical arrangement comprising a folding mirror 130 is arranged to redirect signature radiation, i.e., optical radiation reflected, scattered and/or emitted by said matter towards said at least one detector of the detector system 110.

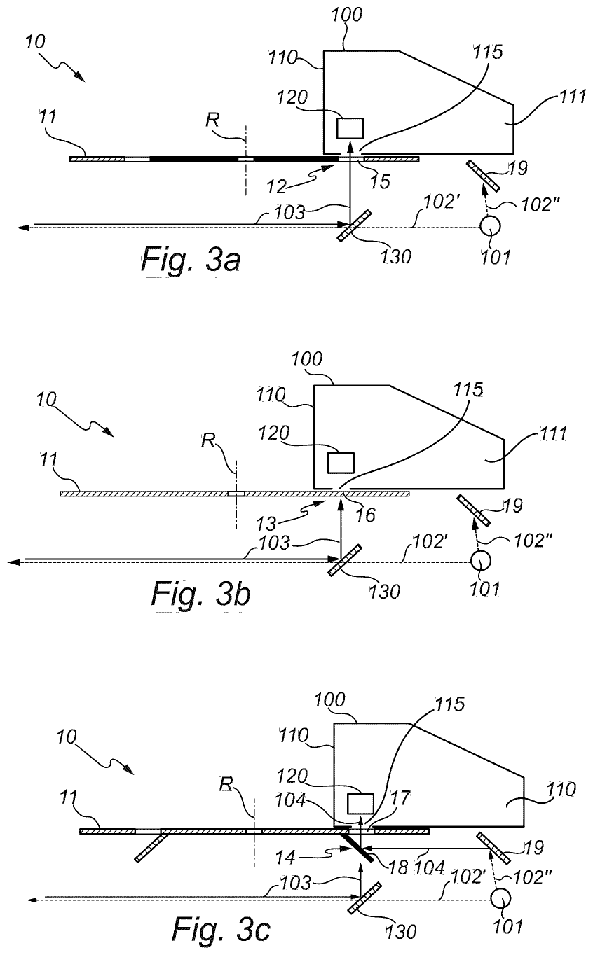

The optical path of the optical radiation from the irradiation arrangement to the matter is shown in FIGS. 3 a-c marked by dashed line 102′. As also shown in FIGS. 3a-c, optical radiation reflected, scattered and/or emitted by the matter in the inspection area, referred to as signature radiation below, follows optical path 103 and is redirected by folding mirror 130 towards a detector of the inspection system 100.

Returning to FIG. 1, the detector system 110 comprises at least one detector (not shown in FIG. 1) adapted to receive and detect optical radiation within a second predetermined wavelength range such as UV, VIS, MIR and/or NIR, which optical radiation is reflected, scattered and/or emitted by the matter. Only the housing 111 of the detector system is shown in FIG. 1. The housing 111 has an opening 115 (not visible in FIG. 1) in a side 113 of the housing 111 for allowing optical radiation to reach the detector 120 of the detector system 110 within the housing 111.

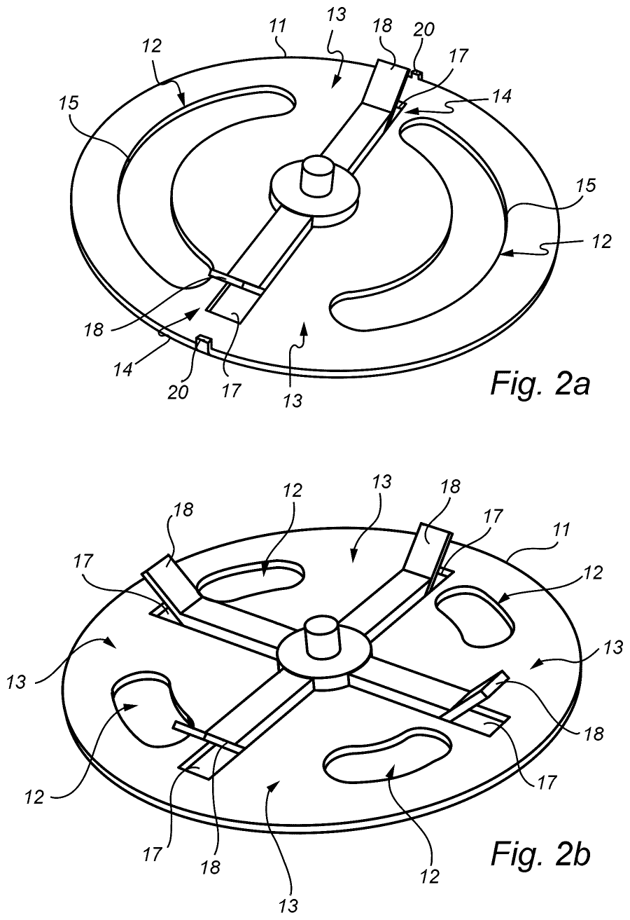

The inspection system also comprises a switching element 11 rotatable about rotation axis R and an actuator or the like for rotating the switching element. The switching element will be described in more detail in relation to FIGS. 2a and 2b. In FIG. 1, the switching element is shown in its white reference position.

FIG. 2a shows an embodiment of the switching element 11. The switching element 11 has a main circular plate or disk rotatable about rotation axis R. The switching element of FIG. 2a has two inspection zones 12, two dark reference zones 13 and two white reference zones 14. The inspection zones 12 are openings 15 or windows in the plate through which signature radiation from the matter may be transmitted. In the example of FIG. 2a, each inspection zone 12 covers a circular section of approximately 120° and has a constant width in the radial direction over this circular section (except for rounded edges at each end of the inspection zone).

As an example, the main plate of the switching element 11 may have a diameter of 207 mm. The opening of each inspection zone may have a width, as seen in the radial direction of the plate, of 30 mm.

Each white reference zone 14 comprises an opening 17 or optical window in the plate of similar size as the opening 15 of the inspection zones 12. Each white reference zone 14 further comprises an associated reflective element 18 extending out of the plate at an angle of 10° to 85°, or 20° to 75°, or 30° to 65°, or 40° to 50°. The reflective element 18 is arranged such that its edge closest to the center of the plate, i.e. closest to the rotation axis R, is connected to the plate, with the opposite edge of the reflective element 18 being farthest from the center of the plate and farthest from the surface of the plate. Thereby, optical radiation following, for example, an optical path parallel to the surface of the plate may be redirected by the reflective element 18 to pass through the opening 17 of the white reference zone with which that reflective element 18 is associated.

Thus, the switching element 11 comprises the same number of openings 17 or optical windows (of white reference zones) as reflective elements 18; each reflective element 18 is associated with a respective opening 17 or optical window. In the embodiment of FIG. 2a, there are two white reference zones 14, thus two openings 17 or optical windows, and two reflective elements 18, each reflective element 18 being associated with a respective one of the two openings 17 or optical windows.

The dark reference zones 13 of the switching element 11 are opaque portions of the switching element 11.

The switching element further comprises encoder element 20. Here, one encoder element 20 is associated with each white reference zone. The encoder elements 20 thus allow the inspection system to determine each time the switching element is in a white reference position. The detector system and the switching element may thus continuously be synchronized during operation of the inspection system to avoid drifting.

Encoder elements may additionally, or alternatively, be arranged and associated with the inspection zones 12 and/or the dark reference zones 13 of the switching element 11.

FIG. 2b shows an alternative embodiment of the switching element 11 comprising four inspection zones 12, four dark reference zones 13 and four white reference zones 14. The embodiment of FIG. 2b differs from that of FIG. 2a mainly in that the inspection zone 12 are smaller, i.e. cover a smaller circular section of the plate of the switching element 11, to make room for the additional dark and white reference zones. As illustrated, each inspection zone 12 in FIG. 2 b covers an angle of approximately 33°, each dark reference zone 13 covers and angle of approximately 35° and each white reference zone 14 covers an angle of approximately 20°. A longer inspection zone can be used to improve the spectral quality of the measurement by integrating in the optics, electronics or in software.

In the embodiment of FIG. 2b, there are four white reference zones 14, thus four openings 17 or optical windows 17, and four reflective elements 18, each reflective element 18 being associated with a respective one of the four openings 17 or optical windows.

It should be noted that no encoder element is shown in FIG. 2b. However, encoder elements may be provided and associated with each inspection zone 12, dark reference zone 13 and/or white reference zone 14 as described in relation to FIG. 2a.

FIGS. 3a-c are schematic illustrations of a cross-section of the switching element 11, while the switching element is in the inspection position, the dark reference position and the white reference position, respectively.

In general, a method for calibrating an inspection system according to the present inventive concept can be illustrated by FIGS. 3a-c. The inspection system 100 comprises:
an irradiation arrangement 101 for emitting optical radiation within a first predetermined wavelength range such as UV, VIS, MIR and/or NIR,
a detector system 110 with at least one detector 120 adapted to receive and detect signature radiation, which signature radiation is optical radiation reflected, scattered and/or emitted by said matter, and
a switching element 11 arranged to be rotatable around a rotation axis R between at least one inspection position (shown in FIG. 3a), at least one dark reference position (shown in FIG. 3b) and at least one white reference position (shown in FIG. 3c), wherein said switching element 11 comprises a plate, which plate comprises: at least one inspection zone 12, each said inspection zone 12 being an opening 15 or window in said plate, at least one dark reference zone 13, each said dark reference zone 13 being an opaque portion 16 of said plate, and at least one white reference zone 14, each said white reference zone 14 comprising an opening 17 or optical window in said plate and an associated reflective element 18, which associated reflective element comprises a reflective surface,
a white reference target element 19, and
an optical arrangement 130 for redirecting said signature radiation towards said switching element 11.

The method comprises:
emitting, by said irradiation arrangement 101, optical radiation within a first predetermined wavelength range such as UV, VIS, MIR and/or NIR, for irradiating said matter,
redirecting, by said optical arrangement 130, said signature radiation towards said switching element 11,
a step of rotating said switching element 11 into an inspection position of said switching element 11, wherein said signature radiation is received from said optical arrangement 130 and transmitted by a respective one of said at least one inspection zone 12 of said switching element 11 and thereafter received by the at least one detector 120,
a step of rotating said switching element 11 into a dark reference position of said switching element 11, wherein a respective one of said at least one dark reference zone 13 blocks all or at least most signature radiation from reaching said detector system 110, and a dark reference level is measured on said respective one of said at least one dark reference zone 13 of the switching element by said at least one detector 120,
a step of rotating said switching element 11 into a white reference position of said switching element 11 and irradiating said white reference target element 19 with reference radiation, which reference radiation is optical radiation emitted by said irradiation arrangement 101, wherein said reflective element 18 of a respective one of said at least one white reference zone 14 blocks at least most signature radiation from reaching said detector system 110, while said reference radiation is:
redirected or reflected, by said white reference target element, towards said switching element,
received and redirected or reflected, by said reflective surface of said reflective element 18, towards said detector system 110, and
received and transmitted, by said opening 17 or optical window of said respective one of said at least one white reference zone 14, towards said detector system 110, and
a white reference level is measured on said white reference target element 19 by said at least one detector 120.

The full path from the irradiation arrangement to the detector as seen from the detector reads e.g.: In the white reference position the detector receives radiation after it was incident on and redirected by a reflective surface of the reflective element 18, which radiation before that was incident on and redirected by the white reference target element 19, and which radiation before that originated from the irradiation arrangement.

In the application text, and to increase the legibility of the text, the full path from a radiation source to a certain element (such as the white reference element) is sometimes omitted, and instead it is simply stated that the radiation originates from said element. In other words, the expression “optical radiation originating from the white reference target element” refers to optical radiation originating from a light source and being redirected by the white reference target element, e.g. by being reflected and optionally scattered by said white reference target element. Moreover, dependent e.g.

on the configuration of the inspection system and the type of material present in the inspection zone, the light form the irradiation arrangement may be reflected, scattered and/or transmitted by said material. Also, if the material is e.g. fluorescent or phosphorescent, light may be emitted by said matter in response to the matter being irradiated by e.g. UV radiation from irradiation arrangement. In relation to this inventive concept, the expression “optical radiation originating from matter in the inspection area” refers to optical radiation originating from a light source and being reflected, scattered and/or transmitted by said matter, as well as light being emitted by said matter.

In each of FIGS. 3a-c, an irradiation source is schematically illustrated at 101. Optical radiation emitted by the irradiation source 101 and directed towards the inspection area is marked by arrows 102′. It should be noted that for clarity of the figure, the parabolic mirrors 140 shown in FIG. 1 are not shown in FIGS. 3a-c.

White reference target element 19 is continuously irradiated by optical radiation from the irradiation source 101. The optical radiation from the irradiation source 101 to the white reference target element is shown by arrow 102″.

Embodiments where the white reference target element is not continuously irradiated are also conceivable. For example, the white reference target element may be irradiated only when the switching element is in a white reference position. For example, the irradiation arrangement may comprise one irradiation source for emitting optical radiation towards the inspection area, and a separate irradiation source for irradiating the white reference target element. The separate irradiation source may for example be turned on only when the white reference level is measured, i.e., when the switching element is in a white reference position.

In the inspection position of the switching element 11 shown in FIG. 3a, the opening 15 of the inspection zone 12 is aligned with an opening or window 115 of the housing of the detector system 110. Thereby, signature radiation from the matter in the inspection zone and redirected by folding mirror 130 has an unobstructed optical path 103 to the detector 120 of the detector system 110.

In the dark reference position of the switching element 11 shown in FIG. 3b, the dark reference zone 13, which consists of an opaque portion 16 of the switching element 11, is aligned with the opening 115 of the housing of the detector system 110. Thereby, signature radiation from the matter in the inspection area and redirected by folding mirror 130 is blocked from reaching the detector 120 of the detector system, at least along optical path 103. If the switching element 11 is arranged close enough to the housing of the detector system 110, at least most of the optical radiation originating outside of the detector system 110 is prevented from reaching the detector 120. Thus a dark reference calibration may be performed.

In the white reference position of the switching element 11 shown in FIG. 3c, the opening 17 of the white reference zone 14 is aligned with the opening 115 of the housing 111 of the detector system 110. Signature radiation from the matter in the inspection area and redirected by folding mirror 130 is blocked from reaching the detector 120 of the detector system 110 by the reflective element 18, at least along optical path 103. Reference radiation reflected or redirected by the white reference target element 19 follows optical path 104 and is redirected by a reflective surface of the reflective element 18 towards the detector 120 of the detector system, through the opening 17 of the white reference zone 14. Thus a white reference calibration may be performed.

In other words, when the inspection system is in use, the irradiation source 101 is on and irradiates matter in the inspection area. In the configuration of FIG. 1, radiation from the source 101 is redirected towards the inspection area by parabolic mirrors 140. The optical path or radiation from the source 101 towards matter in the inspection area is shown at 102′ in FIGS. 3a-c, where parabolic mirrors have been omitted for clarity of the figure. Signature radiation, i.e., optical radiation scattered, reflected and/or emitted by the matter, is reflected or redirected towards the switching element 11 by the folding mirror 130 following optical path 103.

At the same time, the irradiation source 101 also irradiates the white reference target element 19, as illustrated by optical path 102″ in FIGS. 3a-c.

The switching element 11 rotates around axis R. Thus, at different moments in time, a different part of the switching element 11 is aligned with the opening 115 of the housing 111 of the detector system 110. In FIGS. 3a-c, an inspection zone, a dark reference zone, and a white reference zone are aligned with the opening 115, respectively.

When the switching element 11 is in an inspection position as illustrated in FIG. 3a, the signature radiation reflected or redirected by the folding mirror 130 is transmitted towards the detector 120 through the opening or window 15 in the switching element 11. Thereby, a measurement of the signature radiation can be made by the detector 120.

Radiation received by the white reference target element 19 is redirected, or preferably diffusely reflected, by the white reference target element 19. However, the elements are positioned and oriented such that reference radiation reflected or redirected by the white reference target element 19 does not reach the detector 120. The term diffusely reflected refers to radiaton which is reflected and scattered.

When the switching element 11 is in a dark reference position as illustrated in FIG. 3b, the signature radiation reflected or redirected by the folding mirror 130 is blocked by the switching element 11, e.g. by an opaque surface of the switching element, and thus does not reach the detector 120.

Preferably, the opaque portion 16 of the switching element 11 is aligned with the opening 115 and blocks the signature radiation from reaching the detector 120.

Any radiation received by the white reference target element 19 is redirected, or diffusely reflected, by the white reference target element 19 in the same way as when the switching element 11 is in an inspection position, but the reference radiation does not reach the detector 120. In fact, if the switching element 11 is arranged closer to the housing 111 of the detector system 110 than the optical path from the white reference target element then when the switching element 11 is in a dark reference position most light coming from outside of the housing 111 is blocked from entering the housing from 111 at the opening 115 and reaching the detector 120, when the detector 120 performs a dark reference calibration. There are situations where a more remote arrangement of the switching element is conceivable and acceptable measurement results are still achieved.

Note that the reference radiation reflected or redirected by the white reference target element 19 is not shown in FIGS. 3a and 3b.

When the switching element 11 is in a white reference position as illustrated in FIG. 3c, the signature radiation reflected or redirected by the folding mirror 130 is blocked by the switching element 11 and thus does not reach the detector 120. In this position of the switching element 11, the reflective element 18, which protrudes at an angle from the main plate of the switching element 11, extends across the optical path and thereby blocks the signature radiation from reaching the opening 115 of the housing 111 of the detector system 110. Thus, the reflective element 18 blocks the signature radiation, after it has been reflected or redirected by the folding mirror 130, from reaching the detector 120.

Radiation received by the white reference target element 19 is redirected, or diffusely reflected, by the white reference target element 19 in the same way as when the switching element 11 is in an inspection position or in a dark reference position. A photon or light particle emitted by the irradiation source 101 may thus follow optical path 102″ towards the white reference target element 19 as described above. Upon reaching the white reference target element 19, the photon is then reflected or redirected, following optical path 104 towards the reflective element 18, and more precisely the reflective surface of the reflective element 18. Thus, the photon is received and reflected or redirected, by the reflective surface of the reflective element 18 towards the opening or optical window 17, which is aligned with the opening 115 of the housing 111 of the detector system 110. Upon reaching the opening or optical window 17, the photon thus continues on optical path 104, through the opening 17, and thereafter through the opening 115, before reaching the detector 120. It will be appreciated that as one such photon is, for example, on the path from the reflective surface of the reflective element 18 towards the detector 120, another photon is emitted by the irradiation source 101 to subsequently be reflected or redirected by the white reference target element 19 and follow the same path as described above for the first photon. It will also be appreciated that, as the reference radiation is diffusely reflected by the white reference target element 19, not all photons redirected by the white reference target element 19 will reach the reflective element 18. Thus, at least part of the reference radiation which is redirected by the white reference target element 19 follows optical path 104 and is redirected towards the detector 120. Thereby, the detector 120 can perform a white reference calibration.

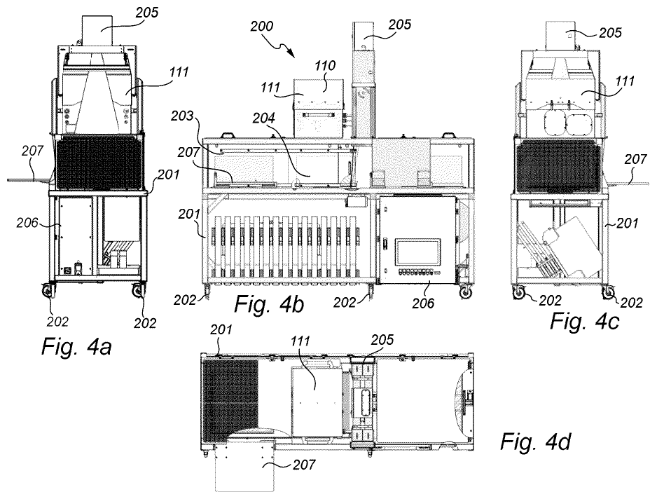

An example of an offline inspection system 200 according to the present inventive concept is shown in FIGS. 4a-d.

By offline system is meant that this inspection system is not part of a fixed installation in e.g. a sorting plant, but may e.g. be arranged at an inspection table or moveable frame. The inspection system 200 is arranged on a movable frame 201 equipped with wheels 202 for ease of transportation. The detector system 110 is arranged within housing 111 with the inspection area (not visible in FIGS. 4a-d) being located underneath housing 111.

The inspection area is arranged within cabinet 203. A door 204 in the cabinet 203 gives access to the inspection area for introducing the matter to be inspected.

The inspection system depicted in FIGS. 4a-d further comprises a Tomra GAIN unit 205 for categorization of the matter through image analysis. A conveyor (not visible in FIGS. 4a-d) may be provided within the cabinet 203 for transporting the matter through the inspection area and/or transporting the matter between the field of view of the detector system 110 and that of the GAIN unit 205.

The offline inspection system 200 comprises a control cabinet 206 for controlling the inspection system, e.g. controlling the detector system 110, GAIN unit 205 and/or conveyor.

The frame 201 is provided with a notebook stand 207 for convenient placement of a notebook during operation of the inspection system.

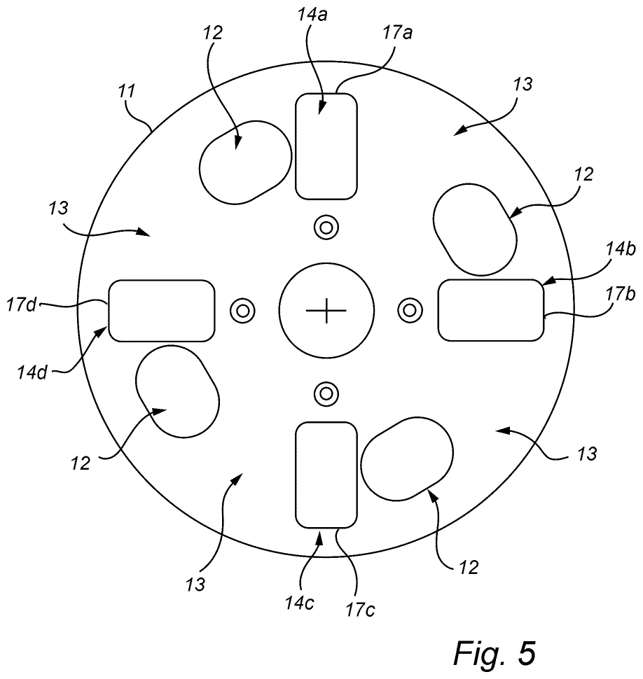

FIG. 5 shows another example of a switching element 11, which comprises at least two white reference zones each comprising an optical window, which optical window comprises an optical filter, said at least two white reference zones are preferably pairwise arranged diametrically opposite each other relative said rotation axis.

In more detail, FIG. 5 shows a switching element 11 having four inspection zones 12, four dark reference zones 13 and four white reference zones 14a-d. In the view of FIG. 5, only the window 17a-d of the respective white reference zones are visible.

The two opposing windows 17a and 17c are provided with and optical filter. The optical filter of windows 17a and 17c are optionally the same, i.e. they optionally have the same optical properties.

In this configuration, the white reference zones 14b and 14d, where no optical filters are present, can be used for a pure white reference. The reference zones 14a and 14c, where optical filters are present, will give different measurements by the detector system, compared to reference zones 14b and 14d. For example, reference zones 14a and 14c can be used for monitoring or controlling the spectral alignment of the detector system.

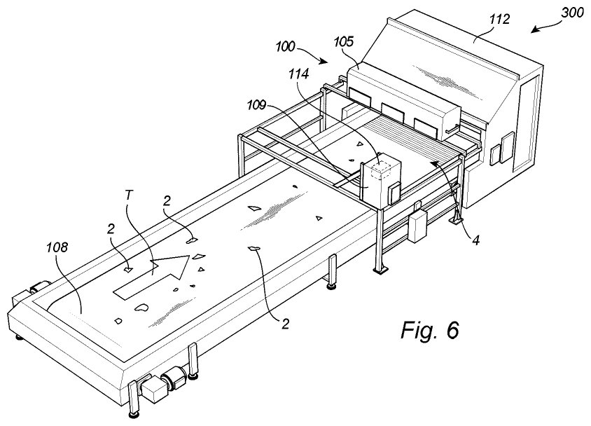

FIG. 6 shows a schematic view of a sorting system 300 provided with an inspection system 100 according to one embodiment of the invention. The sorting system 300 is adapted for compiling information about objects 2 and/or for classification of objects 2 in for example at least a first and a second category.

The inspection system 100 is adapted for inspecting objects 2 within an inspection area 4. The inspection system 100 may be adapted for inspecting objects within the inspection area 4 when said objects 2 are either stationary or moving. In one embodiment, the inspection system 100 is adapted for inspecting objects 2 within the inspection area 4 when said objects 2 are continuously moving. Objects 2 to be inspected may be moving along a predetermined travel path that starts, ends, or passes through the inspection area 4. In the depicted sorting system 300 of FIG. 6, objects 2 travel along a travel path (direction T indicated by arrow) through the inspection area 4 by means of a conveyor system 108.

The objects 2 to be inspected may be movable along said travel path by other means, wherein some non-limiting examples include e.g. by means of sliding (along a horizontal plane or an inclined plane) or freefalling. Hence, the conveyor system 108 of FIG. 6 is optional. The objects may be moved continuously or intermittently along the travel path. In FIG. 6, the inspection system 100 is illustrated as being arranged to inspect objects generally below the inspection system 100. The inspection system 100 is however not limited to only being arranged to inspect objects generally arranged or moving below the inspection system 100; the inspection system 100 may alternatively be arranged and/or oriented to be able to inspect objects 2 generally arranged or moving to the side of the inspection system 100.

The inspection system 100 may comprise a housing 105 for housing at least some of the components of the inspection system 100. The housing 105 may be arranged above or to the side of the predetermined travel path of objects 2 to be inspected. In FIG. 6, the housing 105 is arranged above the conveyor system 108. The inspection system 100 is discussed in more detail in reference to for example FIG. 2 and other figures above.

The depicted sorting system 300 of FIG. 6 further includes optional sorting means 112 provided downstream of inspection area 4. The sorting means 112 may be configured to sort said objects 2 into one of at least a first and a second category. The sorting means 112 may comprise ejection means for providing said sorted objects 2 into one of at least two destinations, for example a first and a second conveying means arranged downstream of the sorting means.

The objects 2 transported by the conveyor system 108 in direction T through the inspection area 4 may be unsorted. Alternatively, the objects 2 transported by the conveyor system 108 in direction T through the inspection area 4 may be sorted, i.e. have been sorted upstream of conveyor system 108.

The depicted sorting system 300 of FIG. 6 may further include a control cabinet 109. The control cabinet 109 may be arranged above the conveyor system 108. The control cabinet 109 includes equipment used for controlling the sorting system 300. The equipment typically includes a processing unit 114 or a control unit for controlling the conveyor system 108, the sorting means 112, and the equipment in the housing 105. The processing unit 114 is typically used to determine properties or a property of the objects 2 based on a measurement carried out by the equipment in the housing 105.

A person skilled in the art realizes that the present invention by no means is limited to the embodiments described above. The features of the embodiments may be combined in different ways, and many variants and modifications are possible within the scope of the appended claims. The word “comprising” does not exclude other elements or steps, and the indefinite articles “a” and “an” preceding an element do not exclude the presence of a plurality of such elements.

1. An inspection system, wherein said inspection system is configured to detect and analyse matter arranged in an inspection area, which inspection system comprises:
an irradiation arrangement for emitting optical radiation within a first predetermined wavelength range such as UV, VIS, MIR and/or NIR for irradiating said matter, a detector system with at least one detector adapted to receive and detect signature radiation within a second predetermined wavelength range such as UV, VIS, MIR and/or NIR, which signature radiation is optical radiation reflected, scattered and/or emitted by said matter,
a switching element arranged to be rotatable around a rotation axis between at least one inspection position, at least one dark reference position and at least one white reference position, and
a white reference target element configured to be irradiated by reference radiation, which reference radiation is optical radiation emitted by said irradiation arrangement
wherein said switching element comprises a plate, which plate comprises:
at least one inspection zone each said inspection zone being an opening or window in said plate,
at least one dark reference zone, each said dark reference zone being an opaque portion of said plate, and
at least one white reference zone, each said white reference zone comprises an associated reflective element which associated reflective element comprises a reflective surface, which reflective element is arranged such that, in said at least one white reference position of the switching element said reflective surface of the reflective element is irradiated by said reference radiation and redirects said reference radiation towards said detector system and said reflective element blocks said signature radiation from reaching said detector system, and
wherein said switching element is arranged to be rotatable around said rotation axis such that:
in each of said at least one inspection position of the switching element, a respective one of said at least one inspection zone transmits said signature radiation towards said detector system,
in each of said at least one dark reference position of the switching element, a respective one of said at least one dark reference zone blocks all or at least most of the signature radiation from reaching said detector system,
wherein:
said white reference target element is further configured to redirect said reference radiation towards said switching element
said inspection system further comprises an optical arrangement for redirecting said signature radiation towards said switching element before it is transmitted by a respective one of said at least one inspection zone,
each said white reference zone further comprises an opening or optical window in said plate, and
in each of said at least one white reference position of the switching element a respective associated reflective element being associated with a respective white reference zone is configured to be irradiated by said signature radiation, and said associated reflective element is configured to block said signature radiation from reaching said detector system, and
said reflective surface of said respective associated reflective element is configured to be irradiated by said reference radiation after said reference radiation has been redirected by said white reference target element and said reflective surface is configured to redirect said reference radiation towards said opening or optical window of said respective white reference zone and said opening or optical window of said respective white reference zone is configured to transmit said reference radiation towards said detector system.

2. The inspection system according to claim 1, wherein said switching element comprises at least two white reference zones each comprising an optical window, which optical window comprises an optical filter, said at least two white reference zones, are preferably pairwise arranged diametrically opposite each other relative said rotation axis.

3. The inspection system according to claim 1, wherein:
said at least one white reference position comprises at least a first white reference position and a second white reference position,
said white reference target element comprises at least a first and a second portion,
said at least one white reference zone comprises a first white reference zone and a second white reference zone,
and wherein said switching element is further arranged such that when arranged
in said first white reference position of the switching element, said first white reference zone redirects and transmits reference radiation redirected by said first portion of said white reference target element towards said detector system, and
in said second white reference position of the switching element, said second white reference zone redirects and transmits reference radiation redirected by said second portion of said white reference target element towards said detector system.

4. The inspection system according to claim 1,
wherein said switching element comprises at least two inspection zones, at least two dark reference zones, and at least two white reference zones, and
wherein each inspection zone ,dark reference zone and white reference zone is arranged diametrically opposite another inspection zone, dark reference zone and white reference zone, respectively, relative said rotation axis.

5. The inspection system according to claim 4, wherein said switching element is arranged such that all planes containing said rotation axis divide said switching element into two parts of substantially equal mass.

6. The inspection system according to claim 1, wherein said reflective element of each white reference zone extends out of a main plane of said plate such that a normal of said reflective surface forms an angle of 10° to 85°, or 20° to 75°, or 30° to 65°, or 40°to 50°with respect to said main plane.

7. The inspection system according to claim 1, wherein said switching element further comprises at least one encoder element, or multiple encoder elements associated with zones, said encoder elements are used in operation to identify the said inspection zone, said dark reference zone or said white reference zone.

8. The inspection system according to claim 1, wherein the detector system is a spectrometry system.

9. A method for calibrating an inspection system configured to detect and analyse matter arranged in an inspection area, which inspection system comprises:
an irradiation arrangement for emitting optical radiation within a first predetermined wavelength range such as UV, VIS, MIR and/or NIR,
a detector system with at least one detector adapted to receive and detect signature radiation, which signature radiation is optical radiation reflected, scattered and/or emitted by said matter, and
a switching element arranged to be rotatable around a rotation axis between at least one inspection position, at least one dark reference position and at least one white reference position, wherein said switching element comprises a plate, which plate comprises: at least one inspection zone, each said inspection zone being an opening or window in said plate, at least one dark reference zone each said dark reference zone being an opaque portion of said plate, and at least one white reference zone
a white reference target element, and
the method comprising
emitting, by said irradiation arrangement, optical radiation within a first predetermined wavelength range such as UV, VIS, MIR and/or NIR, for irradiating said matter,
a step of rotating said switching element into a dark reference position of said switching element, wherein a respective one of said at least one dark reference zone blocks all or at least most signature radiation from reaching said detector system, and a dark reference level is measured on said respective one of said at least one dark reference zone of the switching element by said at least one detector,
wherein
the inspection system further comprises an optical arrangement for redirecting said signature radiation towards said switching element, and
each white reference zone comprises an opening or optical window in said plate and an associated reflective element which associated reflective element comprises a reflective surface, and
the method further comprises:
redirecting, by said optical arrangement, said signature radiation towards said switching element,
a step of rotating said switching element into an inspection position of said switching element, wherein said signature radiation is received from said optical arrangement and transmitted by a respective one of said at least one inspection zone of said switching element and thereafter received by the at least one detector,
a step of rotating said switching element into a white reference position of said switching element and irradiating said white reference target element with reference radiation, which reference radiation is optical radiation emitted by said irradiation arrangement, wherein said reflective element of a respective one of said at least one white reference zone blocks at least most signature radiation from reaching said detector system, while said reference radiation is:
redirected, by said white reference target element towards said switching element,
thereafter redirected, by said reflective surface of said reflective element towards said detector system, and
thereafter transmitted, by said opening or optical window of said respective one of said at least one white reference zone towards said detector system, and
a white reference level is measured on said white reference target element by said at least one detector.

10. A sorting system for sorting objects, comprising:
upstream conveying means and at least a first and second downstream conveying means, wherein each of said upstream conveying means and said at least a first and second downstream conveying means comprises at least one of a conveying belt, a chute or a freefall path,
analysing means configured to analyse and determine at least one property of said objects being transported on said upstream conveying means,
sorting means configured to:
sort said objects into one of at least a first and a second category according to a first and a second criteria based on said at least one property, and
provide said objects sorted into said first category to said first downstream conveying means and said objects sorted into said second category to said second downstream conveying means,
an inspection system according to claim 1, arranged such that said inspection area coincides with at least a part of said first downstream conveying means, wherein said inspection system is configured to:
determine said at least one property of said objects passing through said inspection area,
determine if said at least one property of said objects passing through said inspection area satisfies said first criteria, and
establish a quality score based on the ratio of the number of times said at least one property of an object passing through said inspection area satisfies said first criteria and the number of determinations of said at least one property of an object passing through said inspection area.
